(19) United States
(12) Patent Application Publication
(10) Pub. No.: US 2006/0209070 A1
(43) Pub. Date: Sep. 21, 2006

(54) Apparatus for displaying workflow, method for displaying workflow, and program for displaying workflow

(75) Inventors: Shunichiro Koiso, Kawasaki (JP); Naoyuki Nozaki, Kawasaki (JP); Hirooki Hayashi, Kawasaki (JP); Masahira Deguchi, Kawasaki (JP); Masayuki Kidera, Kawasaki (JP); Hidekatsu Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/167,294

(22) Filed: Jun. 28, 2005

(30) Foreign Application Priority Data
Mar. 17, 2005 (JP) 2005-76720

(51) Int. Cl. G06T 11/20

(52) U.S. Cl. 345/440

(57) ABSTRACT

The present invention provides an apparatus for displaying a workflow, a method for displaying a workflow, and a program for displaying a workflow that can depict a workflow dynamically and easily from a multidirectional viewpoint. The workflow displaying apparatus displays a workflow which connects work symbols representing works using flow symbols representing the relation between works, and includes a work information management unit that manages works and information of attributions of the works, and a display processing unit that displays a workflow based on an attribution specified by the user among attributions managed by the work information management unit.

### BACKGROUND OF THE INVENTION

1. Field of the Invention

The present invention relates to an apparatus for displaying a workflow, a method for displaying a workflow, and a program for displaying a workflow that make the flow of works visible.

2. Description of Related Art

A workflow is used to see an occupation as a flow of a series of works and make the flow visible, in which a work being a unit of the occupation is represented by a work symbol, and the relation between works is represented by a flow symbol such as an arrow. In a conventional workflow displaying apparatus that displays a workflow, as a method to arrange work symbols on a screen, there are generally employed two methods or a method of arranging work symbols on arbitrary positions of a free plane, and a method of arranging work symbols on a coordinate plane one axis of which indicates the flow of time and the other axis of which indicates the structure. Furthermore, a conventional workflow displaying apparatus may be provided with a function of manually editing a complicated occupation and grouping works by a workflow former to simplify the occupation and display thus simplified occupation, and a function of selecting a group by the user to display the details of the group on a separate screen.

As a conventional technique related to the present invention, for example, there is known a Patent Document 1 (Jpn. Pat. Appln. Laid-Open Publication No. 2003-114974). According to the patent document 1, a process attribution map can display a plurality of attribution values of works, and a plurality of works can be compared with each other.

However, in case of utilizing a workflow for the purpose of analyzing an occupation, when a workflow is depicted by only meaningless coordinate axes or fixed coordinate axes, multidirectional observation cannot be performed. The process attribution map disclosed in the patent document 1 is suitable for the purpose of figuring out many attributions at one view, while is not suitable for the purpose of comprehending the flow of an occupation in the multidirectional manner. Furthermore, the user cannot visually determine the difference of attribution values of works even though the user has a look at work symbols. Moreover, in case of a complicated workflow, the user has difficulty in visually figuring out the flow of an occupation or the current process position. Yet moreover, a large number of man-hour is necessary for a workflow former in, for example, forming a flow chart simplified by grouping or a flow chart indicating the details of parts, depending on the difference of the situation of the user.

### SUMMARY OF THE INVENTION

It is therefore an object of the present invention to overcome the above-mentioned drawbacks by providing an apparatus for displaying a workflow, a method for displaying a workflow, and a program for displaying a workflow that can depict a workflow dynamically and easily from a multidirectional viewpoint.

So as to solve the above-mentioned problems, the present invention provides a workflow displaying apparatus that displays a workflow which connects work symbols representing works using flow symbols representing the relation between works, including: a work information management unit that manages works and information of attributions of the works; and a display processing unit that displays a workflow based on attributions managed by the work information management unit.

In the workflow displaying apparatus according to the present invention, the display processing unit makes an attribution specified by a user among attributions managed by the work information management unit correspond to coordinate axes of a workflow, and displays a workflow in which work symbols are arranged based on the value of the attribution specified by the user and the coordinate axes.

In the workflow displaying apparatus according to the present invention, the display processing unit displays a plurality of work symbols to be arranged on the same coordinate in a lump sum as a work group symbol.

In the workflow displaying apparatus according to the present invention, there is further included a group information management unit that manages information of a work group composed of a plurality of works, and the display processing unit displays a workflow in which work symbols of a plurality of works forming the work group are brought together as a work group symbol.

In the workflow displaying apparatus according to the present invention, the display processing unit expands a work group symbol specified by a user to a plurality of work symbols forming the work group symbol to display thus expanded work symbols.

In the workflow displaying apparatus according to the present invention, the display processing unit displays a workflow in which, among attributions managed by the work information management unit, a numeric attribution specified by a user is made to correspond to the display figuration of work symbols.

In the workflow displaying apparatus according to the present invention, the display processing unit displays a workflow in which, among attributions managed by the work information management unit, a non-numeric attribution specified by a user is made to correspond to the display figuration of work symbols.

Furthermore, the present invention provides a workflow displaying method that displays a workflow which connects work symbols representing works using flow symbols representing the relation between works, including: a work information management step that manages works and information of attributions of the works; and a display processing step that displays a workflow based on attributions managed by the work information management step.

In the workflow displaying method according to the present invention, the display processing step makes an attribution specified by a user among attributions managed by the work information management step correspond to coordinate axes of a workflow, and displays a workflow in which work symbols are arranged based on the value of the attribution specified by the user and the coordinate axes.

In the workflow displaying method according to the present invention, there is further included a group information management step that manages information of a work group composed of a plurality of works, and the display processing step displays a workflow in which work symbols of a plurality of works forming the work group are brought together as a work group symbol.

In the workflow displaying method according to the present invention, the display processing step expands a work group symbol specified by a user to a plurality of work symbols forming the work group symbol to display thus expanded work symbols.

In the workflow displaying method according to the present invention, the display processing step displays a workflow in which, among attributions managed by the work information management step, a numeric attribution specified by a user is made to correspond to the display figuration of work symbols.

In the workflow displaying method according to the present invention, the display processing step displays a workflow in which, among attributions managed by the work information management step, a non-numeric attribution specified by a user is made to correspond to the display figuration of work symbols.

Furthermore, the present invention provides a workflow displaying program that makes a computer execute a workflow displaying method that displays a workflow which connects work symbols representing works using flow symbols representing the relation between works, the program making a computer execute steps including: a work information management step that manages works and information of attributions of the works; and a display processing step that displays a workflow based on attributions managed by the work information management step.

In the workflow displaying program according to the present invention, the display processing step makes an attribution specified by a user among attributions managed by the work information management step correspond to coordinate axes of a workflow, and displays a workflow in which work symbols are arranged based on the value of the attribution specified by the user and the coordinate axes.

In the workflow displaying program according to the present invention, the display processing step displays a plurality of work symbols to be arranged on the same coordinate in a lump sum as a work group symbol.

In the workflow displaying program according to the present invention, the program further makes a computer execute a group information management step that manages information of a work group composed of a plurality of works, and the display processing step displays a workflow in which work symbols of a plurality of works forming the work group are brought together as a work group symbol.

In the workflow displaying program according to the present invention, the display processing step expands a work group symbol specified by a user to a plurality of work symbols forming the work group symbol to display thus expanded work symbols.

In the workflow displaying program according to the present invention, the display processing step displays a workflow in which, among attributions managed by the work information management step, a numeric attribution specified by a user is made to correspond to the display figuration of work symbols.

In the workflow displaying program according to the present invention, the display processing step displays a workflow in which, among attributions managed by the work information management step, a non-numeric attribution specified by a user is made to correspond to the display figuration of work symbols.

According to the present invention, since a noted attribution is depicted as coordinate axes or work symbols, the browse user toward a workflow can perform multidirectional analysis. Furthermore, since work symbols are automatically grouped based on attributions as well as work symbols are grouped by definition of the browse user, it is not necessary for a workflow former to form several workflows in advance, which can reduce the number of man-hour significantly. Moreover, since a complicated workflow is displayed with large sections using the concept of groups, the browse user can understand the workflow easily.

### BRIEF DESCRIPTION OF THE DRAWINGS

FIG. 1 shows a block diagram that indicates an example of the configuration of the workflow displaying apparatus according to the present invention;

FIG. 2 shows a table that indicates an example of contents of a work information management table according to the present invention;

FIG. 3 shows a table that indicates an example of contents of a group information management table according to the present invention;

FIG. 4 shows a table that indicates an example of contents of a work symbol shape management table according to the present invention;

FIG. 5 shows a flow chart that indicates an example of the performance of displaying a workflow according to the present invention;

FIG. 6 shows a screen that indicates an example of the workflow display of initial state according to the present invention;

FIG. 7 shows a screen that indicates an example of the operation of changing the display of a workflow according to the present invention;

FIG. 8 shows a flow chart that indicates an example of the performance of automatic group processing according to the present invention;

FIG. 9 shows a screen that indicates an example of automatic group setup according to the present invention;

FIG. 10 shows a screen that indicates an example of the workflow display after the automatic group processing according to the present invention;

FIG. 11 shows a screen that indicates another example of the workflow display after the automatic group processing according to the present invention;

FIG. 12 shows a flow chart that indicates an example of the performance of user definition group processing according to the present invention;

FIG. 13 shows a screen that indicates an example of user definition group setup according to the present invention;

FIG. 14 shows a screen that indicates an example of the workflow display after the user definition group processing according to the present invention;

FIG. 15 shows a flow chart that indicates an example of the performance of work symbol display figuration processing according to the present invention;

FIG. 16 shows a screen that indicates an example of work symbol display figuration setup according to the present invention;

FIG. 17 shows a screen that indicates an example of work symbol shape setup according to the present invention;

FIG. 18 shows a screen that indicates an example of the workflow display after the work symbol display figuration processing by the work symbol shape setup according to the present invention;

FIG. 19 shows a screen that indicates an example of work symbol size setup according to the present invention;

FIG. 20 shows a screen that indicates an example of the workflow display after the work symbol display figuration processing by the work symbol size setup according to the present invention;

FIG. 21 shows a flow chart that indicates an example of the performance of detailed display processing according to the present invention; and

FIG. 22 shows a screen that indicates an example of the workflow display after the detailed display processing according to the present invention.

### DETAILED DESCRIPTION OF THE PREFERRED EMBODIMENTS

Hereinafter, an embodiment according to the present invention will further be described below with reference to the accompanying drawings.

Firstly, the configuration of an apparatus for displaying a workflow according to the present invention will be explained.

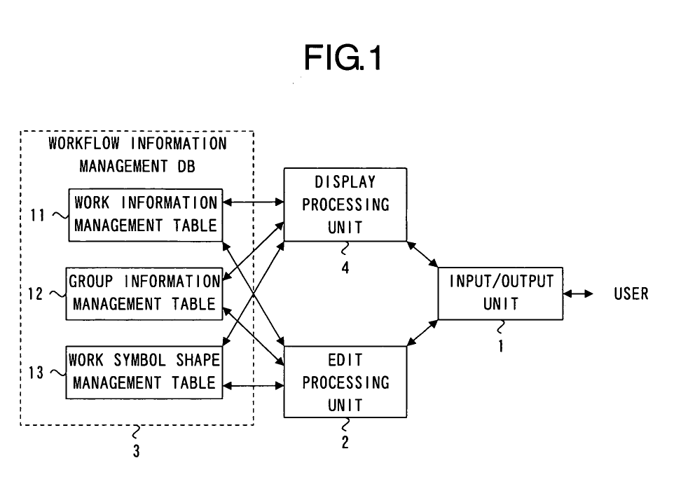

FIG. 1 shows a block diagram that indicates an example of the configuration of the workflow displaying apparatus according to the present invention. The workflow displaying apparatus includes an input/output unit 1, an edit processing unit 2, a workflow information management DB (database) 3, and a display processing unit 4. The workflow information management DB 3 includes a work information management table 11, a group information management table 12, and a work symbol shape management table 13. The input/output unit 1 is a user interface and receives an input from a workflow former or the browse user, and displays a workflow for a workflow former or the browse user.

Next, forming data to display a workflow according to the present invention will be explained.

When a workflow former operates the input/output unit 1, the edit processing unit 2 obtains setups of the work information management table 11, group information management table 12, and work symbol shape management table 13.

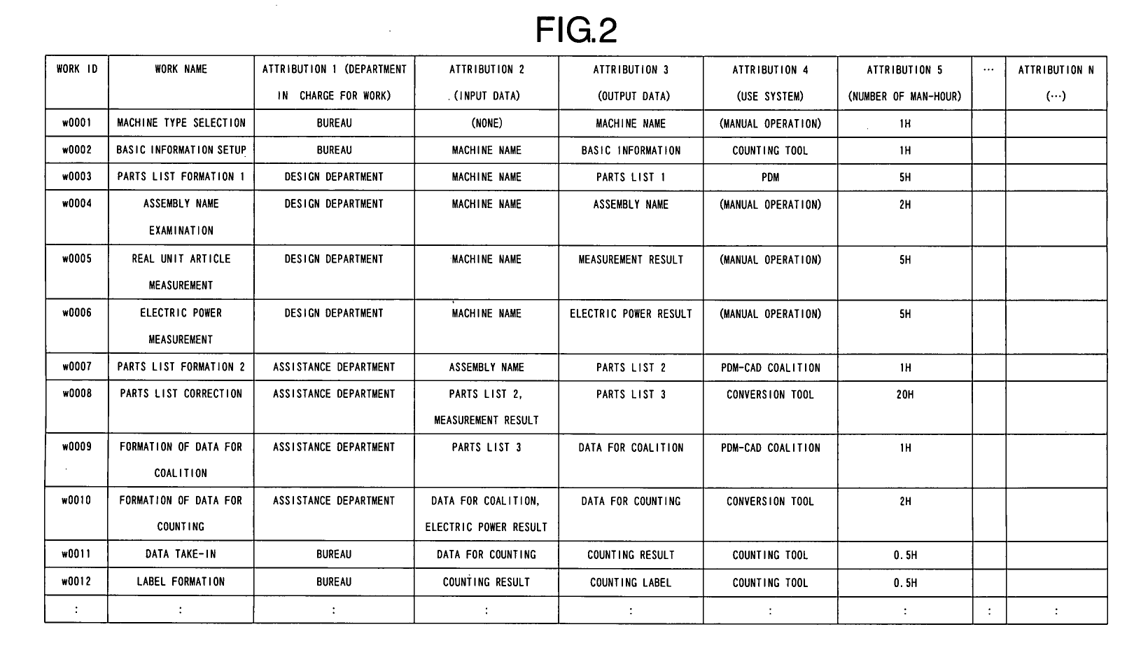

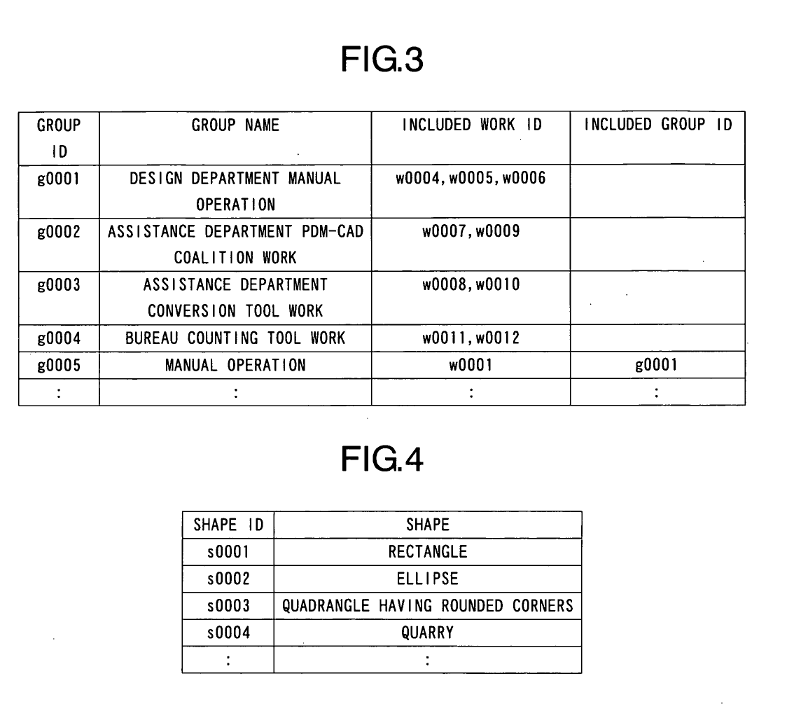

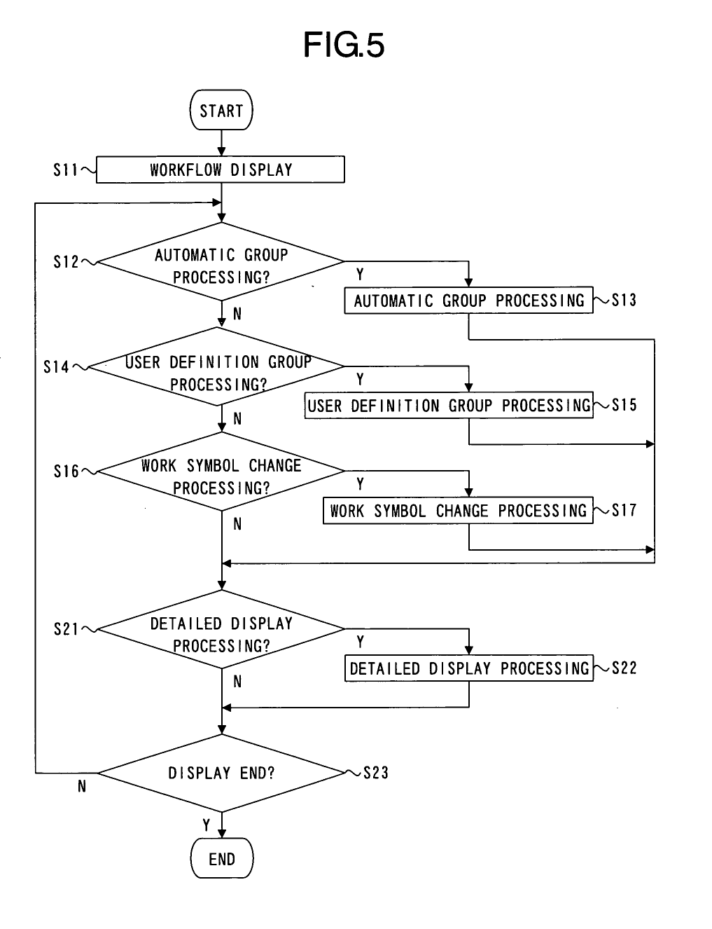

FIG. 2 shows a table that indicates an example of contents of the work information management table 11 according to the present invention. In the work information management table 11, respective rows indicate works and respective columns indicate items such as work ID, work name, attribution 1, attribution 2, . . . , attribution N. In the table, a plurality of attributions are defined for respective works, and N is the number of attributions of works. In this example, there are defined five attributions, and the attribution 1 indicates department in charge for work, the attribution 2 indicates input data, the attribution 3 indicates output data, the attribution 4 indicates use system, and the attribution 5 indicates the number of man-hour. FIG. 3 shows a table that indicates an example of contents of the group information management table 12 according to the present invention. In the group information management table 12, respective rows indicate groups and respective columns indicate items such as group ID, group name, included work ID, and included group ID. The included work ID indicates work ID of works included in a group, and the included group ID indicates group ID of groups included in a group. FIG. 4 shows a table that indicates an example of contents of the work symbol shape management table 13 according to the present invention. In the work symbol shape management table 13, respective rows indicate the kinds of symbols and respective columns indicate items such as symbol ID, and symbol shape.

Next, the performance of displaying a workflow according to the present invention will be explained.

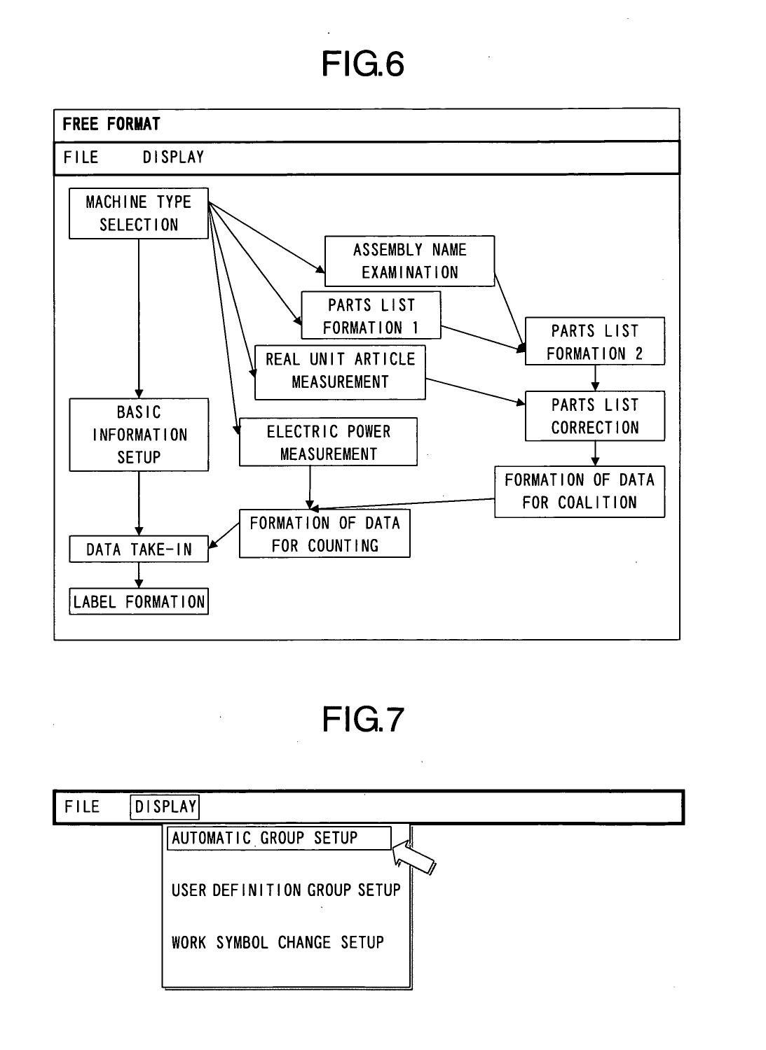

FIG. 5 shows a flow chart that indicates an example of the performance of displaying a workflow according to the present invention. Firstly, the display processing unit 4 forms a workflow of initial state based on information of the workflow information management DB 3, and makes the input/output unit 1 display thus formed workflow (S11). FIG. 6 shows a screen that indicates an example of the workflow display of initial state according to the present invention. The workflow of initial state is depicted using work symbols and flow symbols connecting the work symbols, and is of free format in which there is no coordinate axes and the work symbols are freely arranged. The flow symbols are applied based on the relation of the input data and the output data of the work attributions, or otherwise, applied by making posterior and anterior works have attributions explicitly. During displaying a workflow, the browse user can change the display of the workflow. FIG. 7 shows a screen that indicates an example of the operation of changing the display of a workflow according to the present invention. In the screen, the browse user can select any one of automatic group setup, user definition group setup, or work symbol change setup, as a setup of the display change.

Next, the display processing unit 4 judges whether or not the browse user desires the automatic group processing in the operation of the browse user at the input/output unit 1 (S12). In case the browse user does not desire the automatic group processing (S12, N), the processing goes to S14. On the other hand, in case the browse user desires the automatic group processing (S12, Y), the display processing unit 4 performs the automatic group processing to be described later (S13), and the processing goes to S21.

Next, the display processing unit 4 judges whether or not the browse user desires the user definition group processing in the operation of the browse user at the input/output unit 1 (S14). In case the browse user does not desire the user definition group processing (S14, N), the processing goes to S16. On the other hand, in case the browse user desires the user definition group processing (S14, Y), the display processing unit 4 performs the user definition group processing to be described later (S15), and the processing goes to S21.

Next, the display processing unit 4 judges whether or not the browse user desires the work symbol change processing in the operation of the browse user at the input/output unit 1 (S16). In case the browse user does not desire the work symbol change processing (S16, N), the processing goes to S21. On the other hand, in case the browse user desires the work symbol change processing (S16, Y), the display processing unit 4 performs the work symbol change processing to be described later (S17), and the processing goes to S21.

Next, the display processing unit 4 judges whether or not the browse user desires detailed display processing of a group in the operation of the browse user at the input/output unit 1 (S21). When the browse user carries out the operation of clicking a group etc., detailed display processing of the clicked group is instructed. In case the browse user does not desire the detailed display processing (S21, N), the processing goes to S23. On the other hand, in case the browse user desires the detailed display processing (S21, Y), the display processing unit 4 performs the detailed display processing to be described later (S22), and the processing goes to S23.

Next, the display processing unit 4 judges whether or not the browse user desires display end of workflow in the operation of the browse user at the input/output unit 1 (S23). In case the browse user does not desire the display end (S23, N), the processing returns to S12. On the other hand, in case the browse user desires the display end (S23, Y), the flow ends.

Next, details of the automatic group processing will be explained.

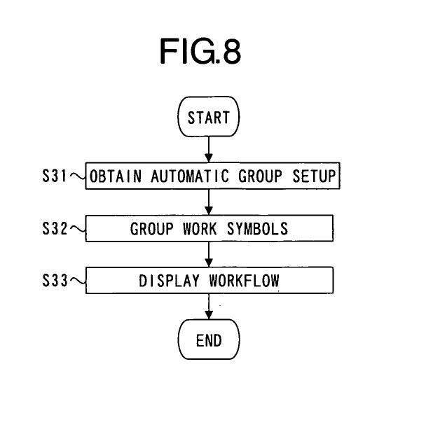

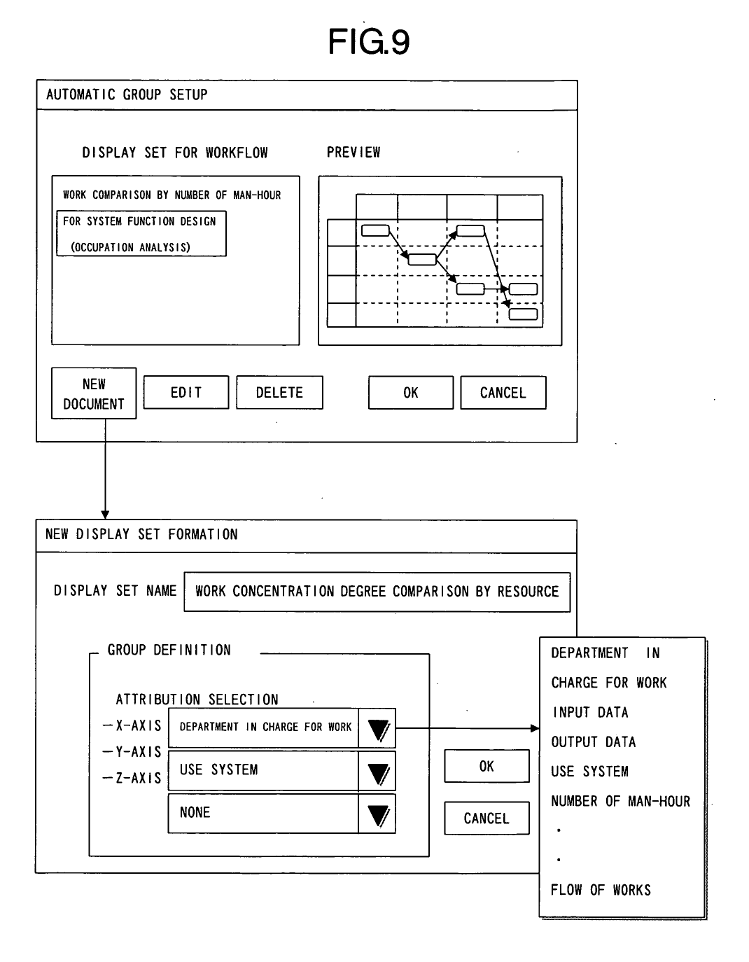

FIG. 8 shows a flow chart that indicates an example of the performance of the automatic group processing according to the present invention. Firstly, when the browse user operates the input/output unit 1, the display processing unit 4 obtains automatic group setup (S31). FIG. 9 shows a screen that indicates an example of the automatic group setup according to the present invention. In the screen, the browse user selects new document of display set including setup of coordinate axes or edit. In case of selecting the new document of display set, the browse user selects attributions to be allocated to respective coordinate axes. The display processing unit 4 presents candidates of attributions to be allocated to coordinate axes by referring to the work information management table 11. In this example, an attribution allocated to the abscissa axis is department in charge for work, while an attribution allocated to the ordinate axis is use system.

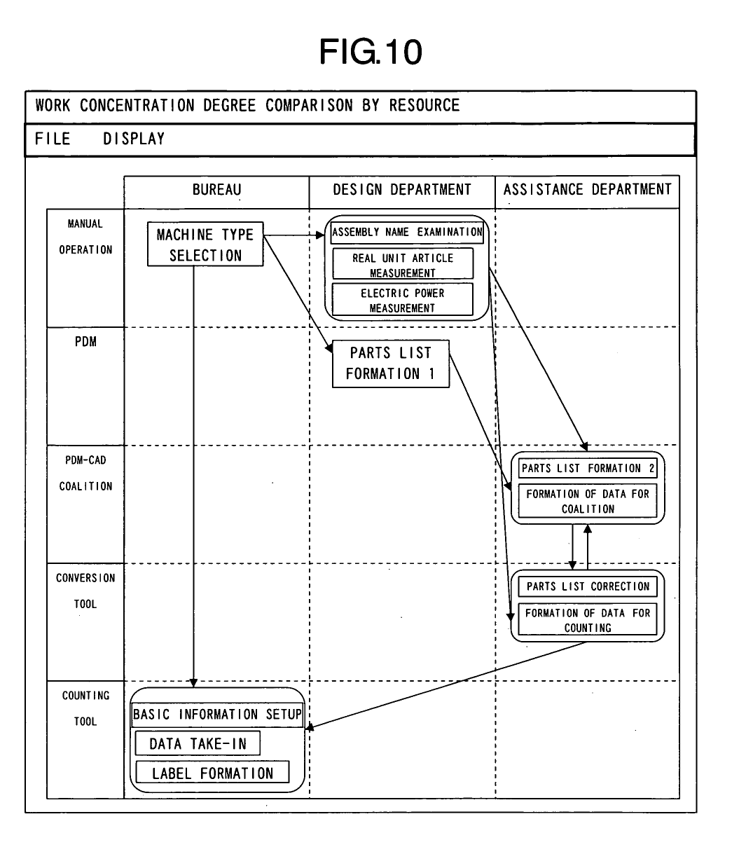

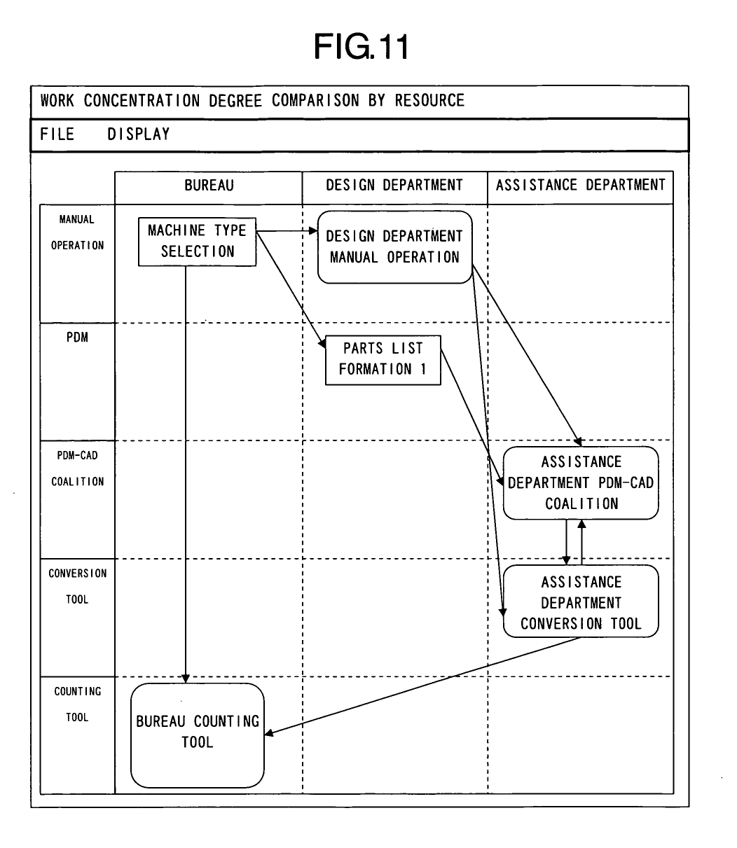

Next, the display processing unit 4 groups work symbols along the coordinate axes in accordance with user definition group setup (S32). That is, a plurality of work symbols to be arranged on the same coordinate are automatically displayed in a lump sum as a work group symbol. Next, the display processing unit 4 displays a changed workflow (S33), and ends the flow. FIG. 10 shows a screen that indicates an example of the workflow display after the automatic group processing according to the present invention. According to the automatic group processing of the example, the degree of concentration to the department in charge for work and to the use system can be seen visually. For example, there are many manual operations in the design department, and it can be seen that operations are not mechanized. FIG. 11 shows a screen that indicates another example of the workflow display after the automatic group processing according to the present invention. As can be seen from FIG. 11, an automatically grouped work group symbol may be rewritten to a new group name to be displayed as a simplified work group symbol.

Next, details of the user definition group processing will be explained.

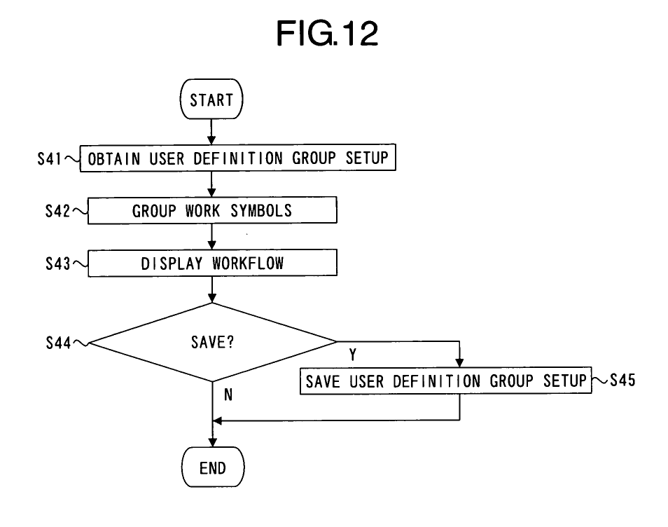

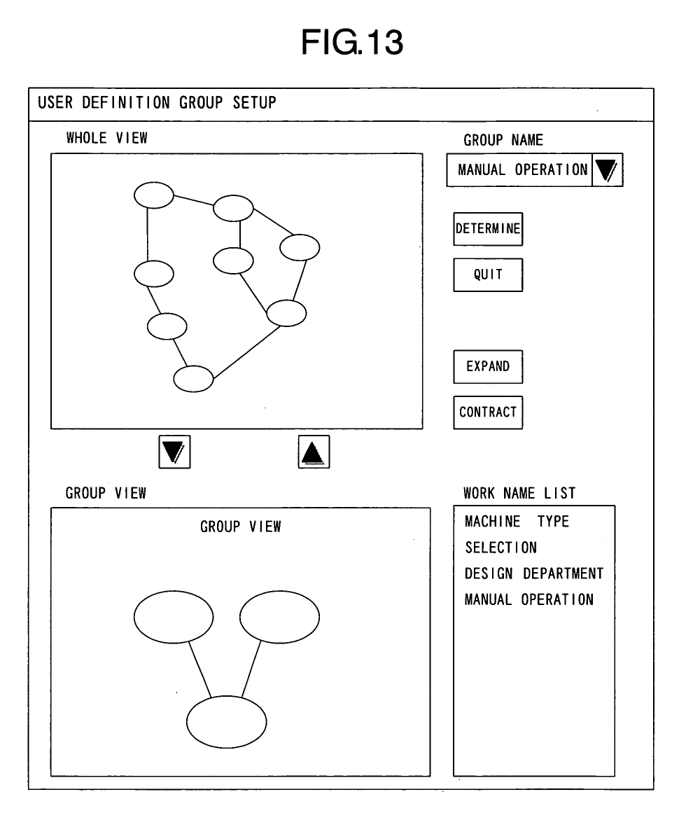

FIG. 12 shows a flow chart that indicates an example of the performance of the user definition group processing according to the present invention. Firstly, when the browse user operates the input/output unit 1, the display processing unit 4 obtains user definition group setup (S41). FIG. 13 shows a screen that indicates an example of the user definition group setup according to the present invention. In the screen, the browse user can form a new group or edit an existing group, and selects works or groups to be grouped. In forming a new group, the display processing unit 4 presents candidates of works to be grouped by referring to the work information management table 11. In editing an existing group, the display processing unit 4 presents candidates of groups to be edited by referring to the group information management table 12. In this example, machine type selection and manual operation in design department in FIG. 11 are defined to be groups of manual operation.

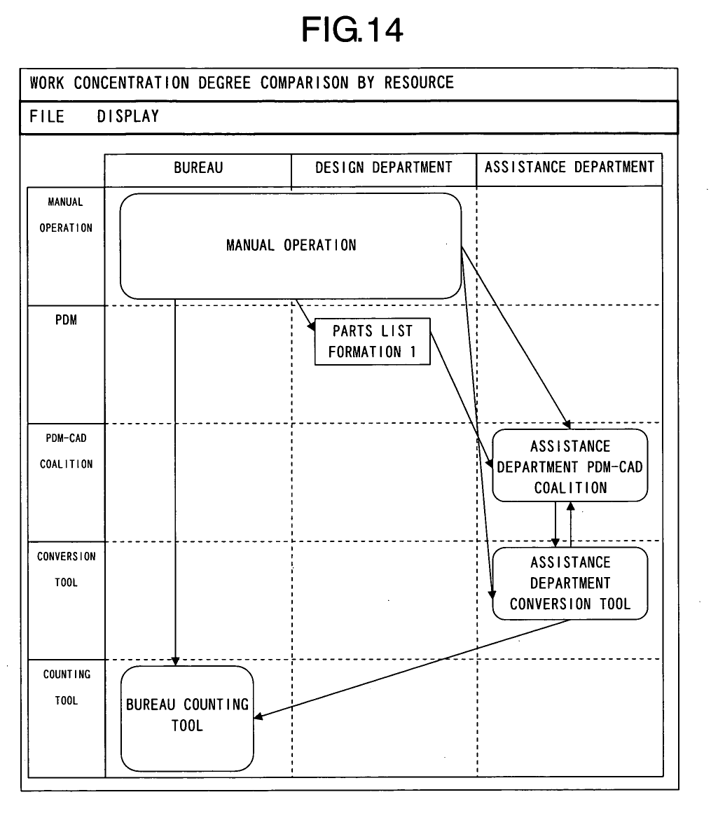

Next, the display processing unit 4 groups work symbols in accordance with the user definition group setup (S42). Next, the display processing unit 4 displays a changed workflow (S43). Then, when the browse user operates the input/output unit 1, it is judged whether or not the user definition group setup should be saved (S44). In case of not saving (S44, N), the flow is ended. On the other hand, in case of saving (S44, Y), the user definition group setup is saved (S45), and the flow is ended. FIG. 14 shows a screen that indicates an example of the workflow display after the user definition group processing according to the present invention. In FIG. 14, machine type selection and manual operation in design department in FIG. 11 are replaced by a group of manual operation to be simplified.

Next, details of work symbol display figuration processing will be explained.

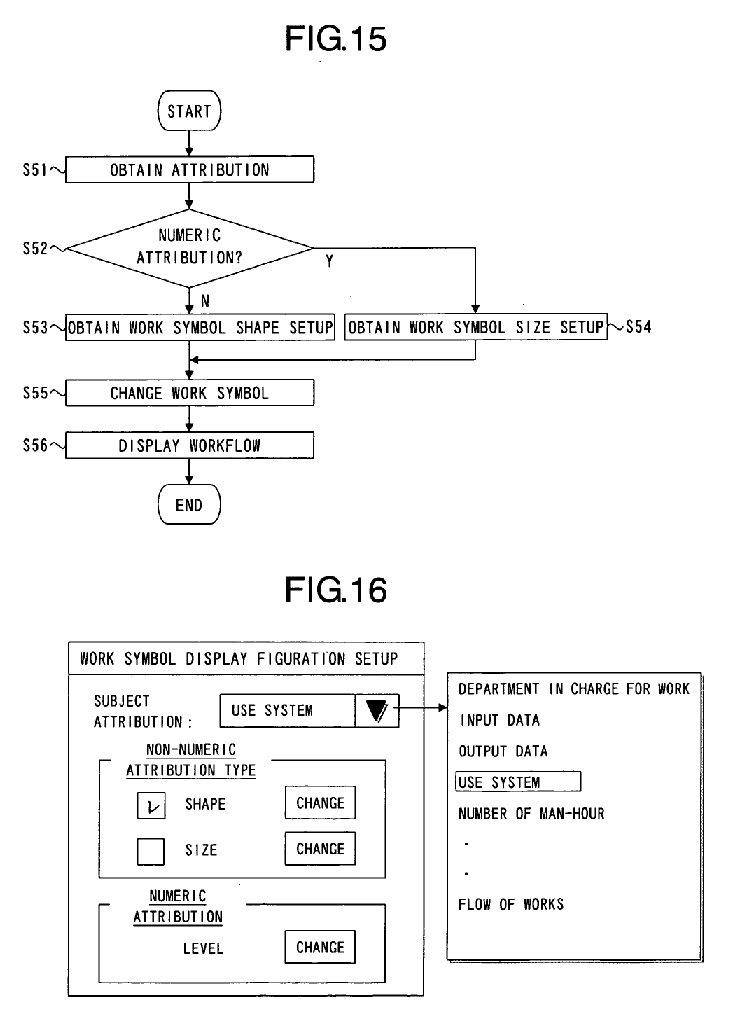

FIG. 15 shows a flow chart that indicates an example of the performance of the work symbol display figuration processing according to the present invention. Firstly, when the browse user operates the input/output unit 1, the display processing unit 4 obtains an attribution to be allocated to work symbol display figuration (S51). FIG. 16 shows a screen that indicates an example of work symbol display figuration setup according to the present invention. In the screen, the browse user selects an attribution to be allocated to a work symbol. The display processing unit 4 presents candidates of attributions by referring to the work information management table 11. Then, the display processing unit 4 judges whether or not an attribution to be allocated to the work symbol display figuration is a numeric attribution (S52).

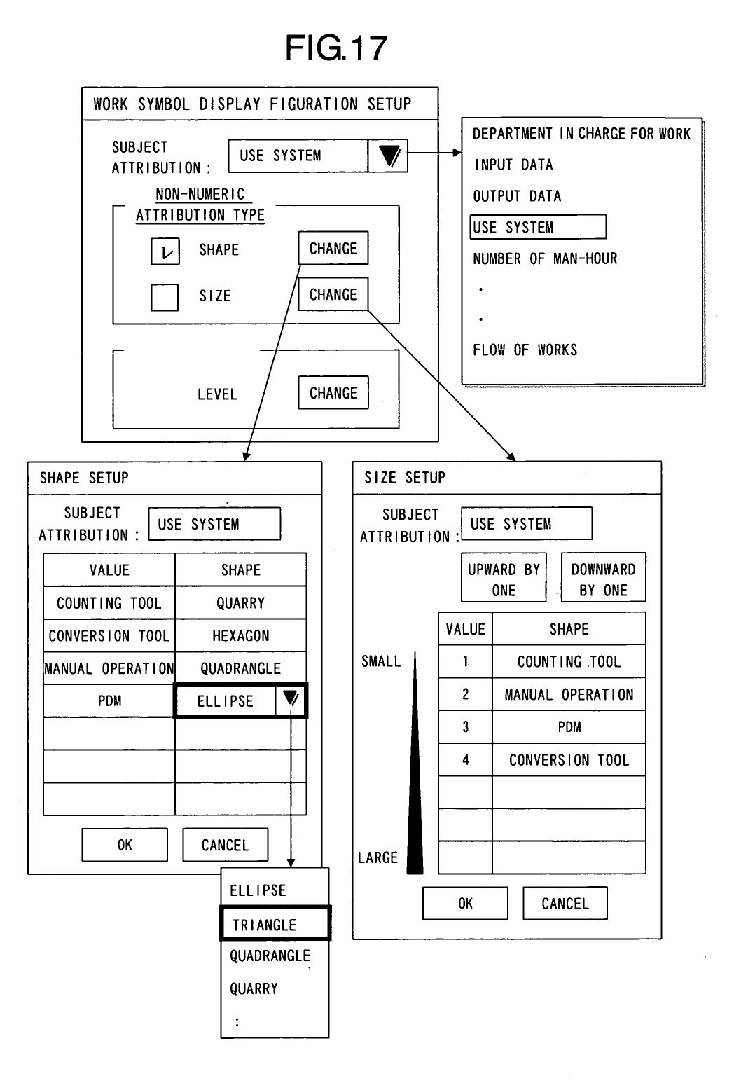

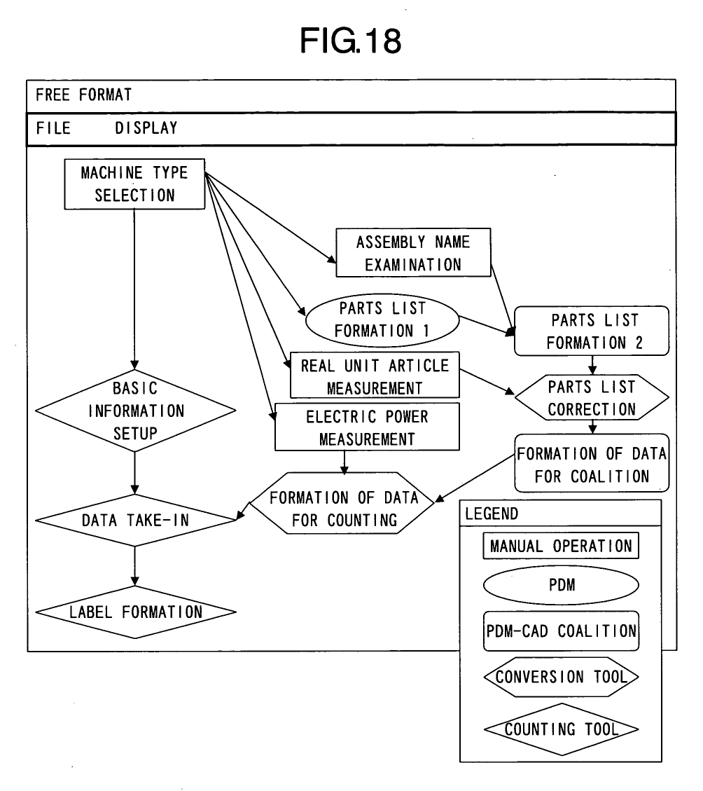

In case of a non-numeric attribution (S52, N), when the browse user operates the input/output unit 1, the display processing unit 4 obtains work symbol shape setup (S53), and the processing goes to step S55. FIG. 17 shows a screen that indicates an example of the work symbol shape setup according to the present invention. In this example, as an attribution that the browse user allocates to the work symbol display figuration, a use system of non-numeric attribution is selected. Next, the browse user performs setup of the relation between the value of non-numeric attribution and the shape of work symbol. The display processing unit 4 presents candidates of shapes of work symbol by referring to the work symbol shape management table 13. In this example, the shape of work symbol indicates the attribution value of use system, and it is set up that, in case a use system is a counting tool, the shape of work symbol is set to be a quarry. Also, the size of work symbol can be setup together with the attribution value. FIG. 18 shows a screen that indicates an example of the workflow display after the work symbol display figuration processing by the work symbol shape setup according to the present invention. In this screen, the work symbol display figuration processing by the work symbol shape setup is applied on the workflow of free format shown in FIG. 6. In addition to the workflow, there is displayed a legend that indicates the correspondence between the shape of work symbol and the attribution value. By carrying out the work symbol display figuration processing, the browse user can visually understand the kind of the value of use system being a selected attribution easily.

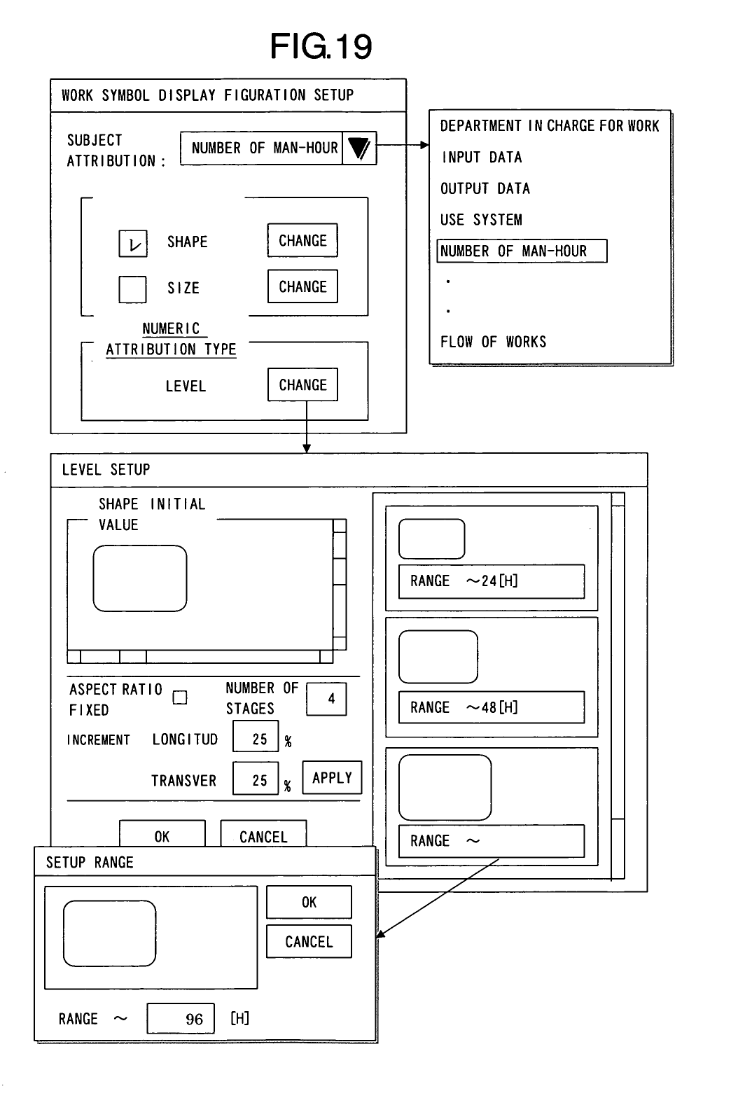

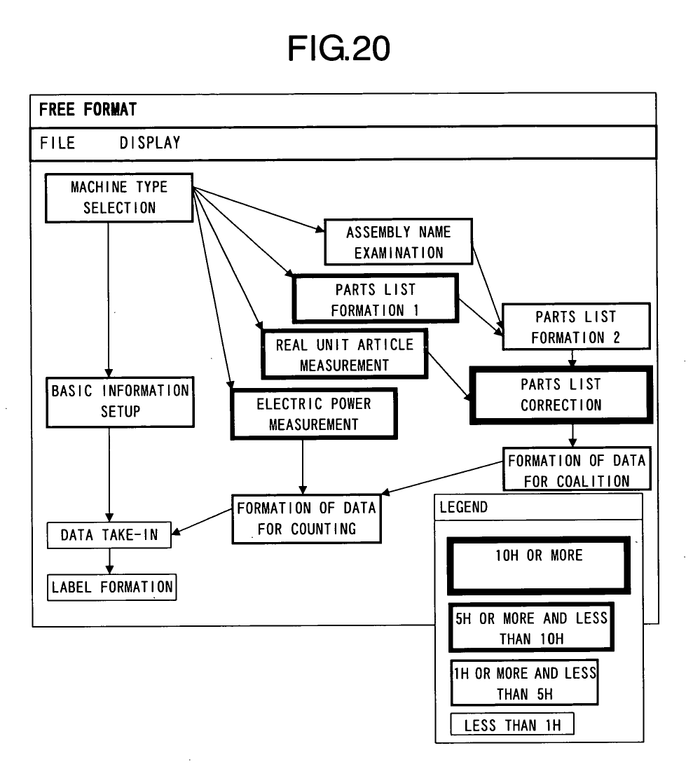

In case of a numeric attribution (S52, Y), when the browse user operates the input/output unit 1, the display processing unit 4 obtains work symbol size setup (S54), and the processing goes to step S55. FIG. 19 shows a screen that indicates an example of the work symbol size setup according to the present invention. In this example, as an attribution that the browse user allocates to the work symbol display figuration, the number of man-hour of numeric attribution is selected. Next, the browse user performs setup of the relation between the value range of numeric attribution and the size of work symbol. In this example, the number of man-hour is classified into four levels, and the size of work symbol is set up for respective levels. FIG. 20 shows a screen that indicates an example of the workflow display after the work symbol display figuration processing by the work symbol size setup according to the present invention. In this screen, the work symbol display figuration processing by the work symbol size setup is applied on the workflow of free format shown in FIG. 6. In addition to the workflow, there is displayed a legend that indicates the correspondence between the size of work symbol and the attribution value. As shown in the legend, in the screen, the number of man-hour is classified into four levels, that is, less than 1H, 1H or more and less than 5H, 5H or more and less than 10H, 10H or more. By carrying out the work symbol display figuration processing, the browse user can visually understand the small and large of the value of the number of man-hour being a selected attribution easily.

Next, the display processing unit 4 changes a work symbol in accordance with the work symbol size setup or the work symbol shape setup (S55). Then, the display processing unit 4 displays a changed workflow (S56), and ends the flow. According to the work symbol change processing, another attribution difference other than coordinate axes can be seen visually.

In the present embodiment, a non-numeric attribution is allocated to the shape of work symbol, while a numeric attribution is allocated to the size of work symbol. The shape and size are examples of display figuration of work symbol, and the attribution may be allocated to other display figuration such as color, pattern, etc.

Next, details of the detailed display processing will be explained.

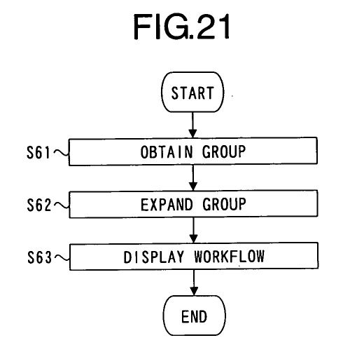

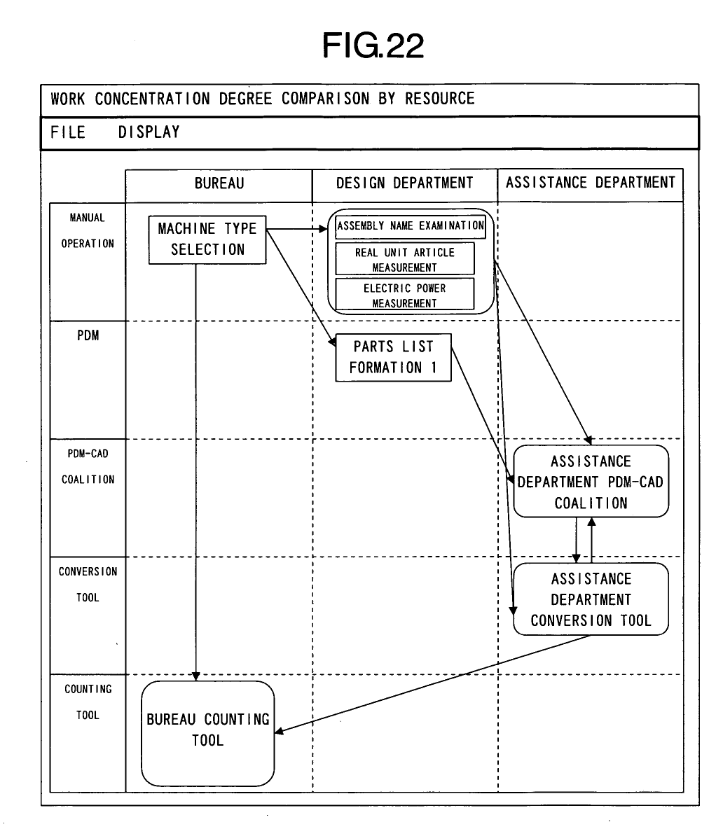

FIG. 21 shows a flow chart that indicates an example of the performance of the detailed display processing according to the present invention. Firstly, when the browse user operates the input/output unit 1, the display processing unit 4 obtains a selected group (S61). Next, the display processing unit 4 expands the selected group to work symbols by referring to the group information management table 12 (S62). Then, the display processing unit 4 displays a changed workflow (S63), and ends the flow. FIG. 22 shows a screen that indicates an example of the workflow display after the detailed display processing according to the present invention. By selecting the work group symbol of manual operation that is grouped in FIG. 14 and instructing the detailed display processing, a screen shown in FIG. 22 is set up, and a work group symbol of manual operation is expanded, and machine type selection, assembly name examination, real unit article measurement, electric power measurement come to appear. By carrying out the detailed display processing, the browse user can figure out the rough workflow using a grouped workflow, and can display part in detail which is necessary for the browse user. Accordingly, one workflow can be shared by many departments.

Furthermore, a program that makes a computer configuring the workflow displaying apparatus execute above-described respective steps can be provided as a workflow displaying program. The program can be executed by a computer configuring the workflow displaying apparatus by making a recording medium readable by the computer store the program. The recording medium which is readable by a computer may be an internal storage device or a ROM, a RAM, etc. that is mounted in the inside of a computer, or a portable storage medium or a CD-ROM, a flexible disk, a DVD disk, a magnetic optical disk, an IC card, etc., or a database retaining a computer program, or other computers and their databases, or a transmission medium on a line.

A work information management unit corresponds to the work information management table in the present embodiment. A group information management unit corresponds to the group information management table in the present embodiment.

What is claimed is:

1. A workflow displaying apparatus that displays a workflow which connects work symbols representing works using flow symbols representing the relation between works, comprising:
a work information management unit that manages works and information of attributions of the works; and
a display processing unit that displays a workflow based on attributions managed by the work information management unit.

2. The workflow displaying apparatus according to claim 1, wherein
the display processing unit makes an attribution specified by a user among attributions managed by the work information management unit correspond to coordinate axes of a workflow, and displays a workflow in which work symbols are arranged based on the value of the attribution specified by the user and the coordinate axes.

3. The workflow displaying apparatus according to claim 2, wherein
the display processing unit displays a plurality of work symbols to be arranged on the same coordinate in a lump sum as a work group symbol.

4. The workflow displaying apparatus according to claim 1, further comprising:
a group information management unit that manages information of a work group composed of a plurality of works,
wherein the display processing unit displays a workflow in which work symbols of a plurality of works forming the work group are brought together as a work group symbol.

5. The workflow displaying apparatus according to claim 4, wherein
the display processing unit expands a work group symbol specified by a user to a plurality of work symbols forming the work group symbol to display thus expanded work symbols.

6. The workflow displaying apparatus according to claim 1, wherein
the display processing unit displays a workflow in which, among attributions managed by the work information management unit, a numeric attribution specified by a user is made to correspond to the display figuration of work symbols.

7. The workflow displaying apparatus according to claim 1, wherein
the display processing unit displays a workflow in which, among attributions managed by the work information management unit, a non-numeric attribution specified by a user is made to correspond to the display figuration of work symbols.

8. A workflow displaying method that displays a workflow which connects work symbols representing works using flow symbols representing the relation between works, comprising:
a work information management step that manages works and information of attributions of the works; and
a display processing step that displays a workflow based on attributions managed by the work information management step.

9. The workflow displaying method according to claim 8, wherein
the display processing step makes an attribution specified by a user among attributions managed by the work information management step correspond to coordinate axes of a workflow, and displays a workflow in which work symbols are arranged based on the value of the attribution specified by the user and the coordinate axes.

10. The workflow displaying method according to claim 8, further comprising:
a group information management step that manages information of a work group composed of a plurality of works,
wherein the display processing step displays a workflow in which work symbols of a plurality of works forming the work group are brought together as a work group symbol.

11. The workflow displaying method according to claim 10, wherein
the display processing step expands a work group symbol specified by a user to a plurality of work symbols forming the work group symbol to display thus expanded work symbols.

12. The workflow displaying method according to claim 8, wherein
the display processing step displays a workflow in which, among attributions managed by the work information management step, a numeric attribution specified by a user is made to correspond to the display figuration of work symbols.

13. The workflow displaying method according to claim 8, wherein
the display processing step displays a workflow in which, among attributions managed by the work information management step, a non-numeric attribution specified by a user is made to correspond to the display figuration of work symbols.

14. A workflow displaying program that makes a computer execute a workflow displaying method that displays a workflow which connects work symbols representing works using flow symbols representing the relation between works, the program making a computer execute steps comprising:
a work information management step that manages works and information of attributions of the works; and
a display processing step that displays a workflow based on attributions managed by the work information management step.

15. The workflow displaying program according to claim 14, wherein
the display processing step makes an attribution specified by a user among attributions managed by the work information management step correspond to coordinate axes of a workflow, and displays a workflow in which work symbols are arranged based on the value of the attribution specified by the user and the coordinate axes.

16. The workflow displaying program according to claim 15, wherein
the display processing step displays a plurality of work symbols to be arranged on the same coordinate in a lump sum as a work group symbol.

17. The workflow displaying program according to claim 14, the program further making a computer execute:
a group information management step that manages information of a work group composed of a plurality of works,
wherein the display processing step displays a workflow in which work symbols of a plurality of works forming the work group are brought together as a work group symbol.

18. The workflow displaying program according to claim 17, wherein
the display processing step expands a work group symbol specified by a user to a plurality of work symbols forming the work group symbol to display thus expanded work symbols.

19. The workflow displaying program according to claim 14, wherein
the display processing step displays a workflow in which, among attributions managed by the work information management step, a numeric attribution specified by a user is made to correspond to the display figuration of work symbols.

20. The workflow displaying program according to claim 14, wherein
the display processing step displays a workflow in which, among attributions managed by the work information management step, a non-numeric attribution specified by a user is made to correspond to the display figuration of work symbols.
